(19) United States
(12) Patent Application Publication
(10) Pub. No.: US 2025/0392025 A1
(43) Pub. Date: Dec. 25, 2025

(54) SECONDARY BATTERY

(71) Applicant: MURATA MANUFACTURING CO., LTD., Kyoto (JP)

(72) Inventors: Fumihito ISHII, Kyoto (JP); Muneaki ANDO, Kyoto (JP)

(21) Appl. No.: 19/219,059

(22) Filed: May 27, 2025

(30) Foreign Application Priority Data
Jun. 19, 2024 (JP) 2024-098691
Mar. 13, 2025 (JP) 2025-040384

(51) Int. Cl. H01M 50/593; H01M 10/0587

(52) U.S. Cl. CPC H01M 50/593; H01M 10/0587

(57) ABSTRACT

A secondary battery is provided and including a wound electrode assembly in which a positive electrode, a negative electrode, and a separator disposed between the positive electrode and the negative electrode are wound; and an electrolyte, the wound electrode assembly and the electrolyte being enclosed in an exterior body, at least the positive electrode including a wound current collector, a first positive electrode material layer and a second positive electrode material layer provided on both surfaces of the current collector, and a pair of exposed portions including a first exposed portion in which one surface of a local portion of the current collector is exposed and a second exposed portion in which the other surface facing the one surface in a thickness direction of the positive electrode is exposed.

### CROSS REFERENCE TO RELATED APPLICATIONS

The present application claims priority to Japanese Patent Application No. 2025-040384, filed on Mar. 13, 2025 and Japanese Patent Application No. 2024-098691, filed on Jun. 19, 2024, the entire contents of which are incorporated herein by reference.

### BACKGROUND

The present disclosure relates to a secondary battery.

Conventionally, a secondary battery that can be repeatedly charged and discharged has been used for various applications. For example, secondary batteries are used as power supplies for electronic devices such as smart phones and notebook computers.

A secondary battery has a structure in which an electrode assembly including a positive electrode, a negative electrode, and a separator disposed between the positive electrode and the negative electrode, and an electrolytic solution are housed in a housing portion. The positive electrode includes a current collector and a positive electrode material layer containing a positive electrode active material provided on the current collector, and the negative electrode includes a current collector and a negative electrode material layer containing a negative electrode active material provided on the current collector.

In the secondary battery, a wound electrode assembly in which the positive electrode, the negative electrode, and the separator are wound may be used. In this case, it is possible to adopt a configuration in which an exposed portion in which both surfaces of the current collector are exposed so as to locally face each other is formed at a predetermined portion in a circumferential direction of the strip-shaped electrode, particularly the strip-shaped positive electrode, and a tab for current collection is connected to the exposed portion on one side. Since the current collector is exposed at the exposed portion, when an internal short-circuit occurs at the exposed portion, a large current may flow through the short-circuited portion to increase the calorific value. Therefore, an insulating tape can be provided so as to cover the exposed portion locally provided on both surfaces of the current collector and the positive electrode material layers located on both sides of each exposed portion in the circumferential direction of the positive electrode.

### SUMMARY

The present disclosure relates to a secondary battery.

Here, when an impact is applied to the secondary battery from the outside, it is conceivable that the positive electrode of the wound electrode assembly, which is a constituent element of the secondary battery, is also affected by an external force associated with the impact.

In particular, when tape ends of the insulating tape are arranged so as to be aligned in a thickness direction of the positive electrode, two step portions formed on the tape end portions can be arranged so as to be aligned in the thickness direction of the positive electrode. In addition, when the end portions of the positive electrode material layer formed on both surfaces of the current collector are arranged so as to be aligned in the thickness direction of the positive electrode, two step portions can be arranged so as to be aligned in the thickness direction of the positive electrode in a local portion of the insulating tape covering the end portion of the positive electrode material layer.

When the external force is applied in the thickness direction of the positive electrode in the arrangement state of the step portions, due to the form of the two step portions aligned in the thickness direction of the positive electrode, stress tends to concentrate on the local portions of the two separators arranged opposite to each other on both sides of the positive electrode. As a result, the separator is broken, and occurrence of a short circuit may be concerned.

The present disclosure has been devised in view of such circumstances according to an embodiment. In an embodiment, the present disclosure provides a secondary battery capable of suppressing stress concentration on a local portion of a separator disposed to face a positive electrode.

In an embodiment of the present disclosure, provided is a secondary battery including: a wound electrode assembly in which a positive electrode, a negative electrode, and a separator disposed between the positive electrode and the negative electrode are wound; and an electrolyte, the wound electrode assembly and the electrolyte being enclosed in an exterior body, at least the positive electrode including a wound current collector, a first positive electrode material layer and a second positive electrode material layer provided on both surfaces of the current collector, and a pair of exposed portions including a first exposed portion in which one surface of a local portion of the current collector is exposed and a second exposed portion in which the other surface facing the one surface in a thickness direction of the positive electrode is exposed, the positive electrode further including: a positive electrode tab provided on one of the first exposed portion and the second exposed portion, a first insulating member covering the first exposed portion and the first positive electrode material layers located on both sides of the first exposed portion in a circumferential direction of the positive electrode, and a second insulating member covering the second exposed portion and the second positive electrode material layers located on both sides of the second exposed portion in the circumferential direction of the positive electrode, wherein in the circumferential direction of the positive electrode, one end side of the first insulating member and one end side of the second insulating member are arranged to be shifted from each other, and the other end side of the first insulating member and the other end side of the second insulating member are arranged to be shifted from each other, and a first end portion of the first positive electrode material layer and a first end portion of the second positive electrode material layer located on one side of the pair of exposed portions with reference to the circumferential direction of the positive electrode are arranged to be shifted in the circumferential direction of the positive electrode, and a second end portion of the first positive electrode material layer and a second end portion of the second positive electrode material layer located on the other side of the pair of exposed portions are arranged to be shifted in the circumferential direction of the positive electrode.

According to the secondary battery according to an embodiment of the present disclosure, stress concentration on a local portion of the separator disposed to face the positive electrode can be suppressed, and breakage of the separator can be suppressed.

### BRIEF DESCRIPTION OF THE FIGURES

FIG. 1 is a sectional view schematically illustrating a general configuration of a secondary battery;

FIG. 2 is a schematic partial sectional view of a positive electrode with a positive electrode tab in a radial direction of a wound electrode assembly of a secondary battery according to an embodiment of the present disclosure;

FIG. 3 is a schematic partial sectional view of a positive electrode with a positive electrode tab in a radial direction of a wound electrode assembly of a secondary battery according to another embodiment of the present disclosure;

FIG. 4 is a schematic partial sectional view of a positive electrode with a positive electrode tab in a radial direction of a wound electrode assembly of a secondary battery according to still another embodiment of the present disclosure;

FIG. 5 is a schematic partial sectional view of a positive electrode with a positive electrode tab in a radial direction of a wound electrode assembly of a secondary battery according to still another embodiment of the present disclosure; and

FIG. 6 is a schematic partial sectional view of a positive electrode with a positive electrode tab in a radial direction of a wound electrode assembly of a conventional secondary battery.

### DETAILED DESCRIPTION

Hereinafter, a secondary battery according to an embodiment of the present disclosure will be described including with reference to drawings. Various elements in the drawings are merely shown schematically and exemplarily for the understanding of the present disclosure, and the appearance, dimensional ratios, and the like may be different from actual ones.

The term “secondary battery” in the present specification means a battery that can be repeatedly charged and discharged. The “secondary battery” is not unduly restricted by the name of the secondary battery, which can encompass, for example, a “power storage device” and the like. The term “sectional view” used in the present specification is a state when viewed from a direction substantially perpendicular to the thickness direction based on the stacking direction of the electrode materials constituting the secondary battery. The terms “up-down direction” and “left-right direction” directly or indirectly used in the present specification respectively correspond to the up-down direction and the left-right direction in the drawing. According to a preferred aspect, it can be understood that the downward direction in the vertical direction (i.e., the direction in which gravity acts) corresponds to a “downward direction”, whereas the opposite direction corresponds to an “upward direction”.

Various numerical ranges mentioned herein are intended to include the numerical values themselves of the lower and upper limits. That is, when a numerical range such as 1 to 10 is taken as an example, it can be interpreted as including the lower limit of “1” and also including the upper limit of “10”.

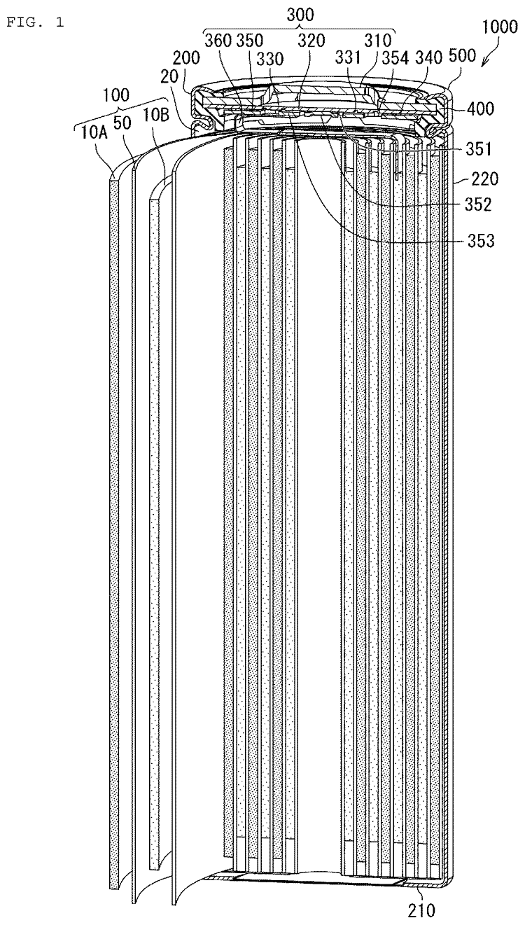

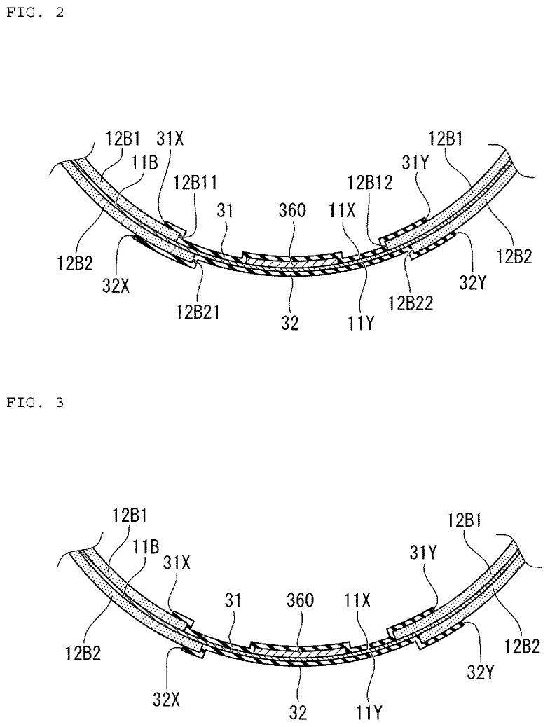

First, a basic configuration of a secondary battery will be described with reference to FIG. 1. A secondary battery 1000 has a structure in which an electrode assembly 100 and an electrolyte 20 are housed and enclosed inside a predetermined housing portion 500. The electrode assembly 100 may include a positive electrode 10B, a negative electrode 10A, and a separator 50 disposed between the positive electrode 10B and the negative electrode 10A. In the present disclosure, the electrode assembly 100 may be a wound electrode assembly. The wound electrode assembly is obtained by winding a plurality of electrode constituting layers each including a positive electrode, a negative electrode, and a separator.

The positive electrode 10B includes at least a positive electrode material layer and a positive electrode current collector. The positive electrode material layer contains a positive electrode active material as an electrode active material. In the present disclosure, in the positive electrode 10B in the electrode assembly 100, the positive electrode material layers are provided on both surfaces of the positive electrode current collector.

The negative electrode 10A includes at least a negative electrode material layer and a negative electrode current collector. The negative electrode material layer contains a negative electrode active material as an electrode active material. For example, for each of a plurality of negative electrodes 10A in the electrode assembly 100, the negative electrode material layer may be provided on both surfaces of the negative electrode current collector, or may be provided only on one surface of the negative electrode current collector.

The electrode active materials contained in the positive electrode 10B and the negative electrode 10A, that is, the positive electrode active material and the negative electrode active material are substances directly involved in the transfer of electrons in the secondary battery, and are main substances of the positive and negative electrodes, which are responsible for charging and discharging, that is, a battery reaction. More specifically, ions are brought into the electrolyte due to the “positive electrode active material contained in the positive electrode material layer” and the “negative electrode active material contained in the negative electrode material layer”, and the ions move between the positive electrode and the negative electrode to transfer electrons, and thus charging and discharging is performed. The positive electrode material layer and the negative electrode material layer may be layers particularly capable of occluding and releasing lithium ions. More specifically, the secondary battery according to the present disclosure may be a non-aqueous electrolyte secondary battery in which lithium ions move between the positive electrode and the negative electrode through a non-aqueous electrolyte to charge and discharge the battery. When lithium ions are involved in charging and discharging, the secondary battery according to the present disclosure corresponds to a so-called “lithium ion battery”, and the secondary battery includes layers capable of occluding and releasing lithium ions as the positive electrode and the negative electrode.

In view of a lithium ion battery, the positive electrode active material may be a material that contributes to occlusion and release of lithium ions. That is, the positive electrode layer may contain any one kind or two or more kinds among positive electrode materials capable of occluding and releasing lithium. From such a viewpoint, the positive electrode active material may be, for example, a lithium-containing compound. The lithium-containing compound is not particularly limited in its type, but may be, for example, a lithium-containing composite oxide, a lithium-containing phosphate compound, or the like. This is because a high energy density can be easily obtained.

The lithium-containing composite oxide is a generic name of oxides containing lithium and one or two or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one or two or more of other elements as constituent elements, and may have, for example, a crystal structure such as an olivine type crystal structure. The type of the other elements is not particularly limited as long as the element is any one or two or more of any elements. Among them, as the other elements, one or two or more of elements belonging to Groups 2 to 15 in the long-period periodic table is preferable. More specific examples of the other elements include nickel (Ni), cobalt (Co), manganese (Mn), and iron (Fe). This is because a high voltage is likely to be obtained by these additive elements.

The positive electrode material layer may contain a binder. A positive electrode conductive agent may also be contained in the positive electrode material layer to facilitate the transfer of electrons promoting the battery reaction. The binder of the positive electrode may contain, for example, any one of, or two or more of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent may contain any one kind or two or more kinds among, for example, carbon materials. The carbon material may be, for example, graphite, carbon black, acetylene black, ketjen black, or the like. However, the positive electrode conductive agent may be a metal material, a conductive polymer, and the like, as long as it is a material exhibiting conductivity.

Similarly, the negative electrode active material of the negative electrode material layer may be a material that contributes to occlusion and release of lithium ions. That is, the negative electrode layer may contain any one or two or more among negative electrode materials capable of occluding and releasing lithium. From such a viewpoint, the negative electrode active material may be, for example, various carbon materials, metal-based materials, and/or other materials.

When the carbon material is used as the negative electrode active material, the crystal structure shows a very small change when lithium is occluded and when lithium is released, so that a high energy density can be easily and stably obtained. Further, the carbon material also functions as a negative electrode conductive agent, and thus the negative electrode layer easily has an improved conductivity.

The “metal-based material” used as the negative electrode active material is a generic name of materials containing any one kind or two or more kinds among metal elements and metalloid elements as constituent elements. When a carbon material is used as the negative electrode active material, a high energy density is likely to be obtained. The metal-based material may be a simple substance, an alloy, a compound, two or more of these, or may be a material at least a part of which has phases composed of one of, or two or more of these. However, the alloy may include a material containing one or more metal elements and one or more metalloid elements in addition to a material composed of two or more of metal elements. The alloy may also contain a non-metallic element. The construction of this metal-based material may be, for example, a solid solution, a eutectic (eutectic mixture), an intermetallic compound, and a material in which two or more among these coexist.

In addition, the negative electrode material may be any one or two or more among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Furthermore, a negative electrode conductive agent may be included in the negative electrode material layer to facilitate the transfer of electrons promoting the battery reaction. The binder that may be contained in the negative electrode material layer is not particularly limited, but examples thereof include at least one selected from the group consisting of styrene-butadiene rubber, polyacrylic acid, polyvinylidene fluoride, polyimide-based resin, and polyamideimide-based resin. The negative electrode conductive agent that may be contained in the negative electrode material layer is not particularly limited, and examples of the negative electrode conductive agent may include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like. Note that the negative electrode material layer may contain a component derived from a thickener component (for example, a carboxymethyl cellulose) used during battery production.

The positive electrode current collector and the negative electrode current collector used in the positive electrode 10B and the negative electrode 10A are members that contribute to collecting and supplying electrons generated in the electrode active material due to the battery reaction. Such an electrode current collector may be a sheet-shaped metal member. The electrode current collector may have a single layer or multiple layers. Further, the electrode current collector may have a porous or perforated form. For example, the current collector may be a metal foil, a punching metal, a net, an expanded metal, or the like. The positive electrode current collector used for the positive electrode may include, for example, a metal foil containing at least one selected from the group consisting of aluminum, nickel, stainless steel, and the like. On the other hand, the negative electrode current collector used for the negative electrode may include, for example, a metal foil containing at least one selected from the group consisting of copper, aluminum, nickel, stainless steel, and the like.

The separator 50 provided between the positive electrode 10B and the negative electrode 10A is a member provided from viewpoints such as preventing a short circuit due to contact between the positive and negative electrodes and holding the electrolyte. In other words, the separator 50 is a member that isolates the positive electrode 10B and the negative electrode 10A from each other, and allows ions (for example, lithium ions) to pass therethrough while preventing a short circuit of current due to contact between both electrodes. For example, the separator 50 may be a porous or microporous insulating member, which may have a membrane form due to its small thickness.

This separator 50 may be, for example, any one of, or two or more of porous films of synthetic resins and/or ceramics, and the like, and it may be a laminated film of two or more of porous films. The synthetic resin used for the separator 50 is, for example, polytetrafluoroethylene, polypropylene, polyethylene, and the like. For example, the separator 50 may include, a porous film (substrate layer) and a polymer compound layer provided on one side or both sides of the substrate layer. This improves the close contact of the separator 50 to the positive electrode and may improve the close contact of the separator 50 to the negative electrode, and thus the distortion of the wound electrode assembly is likely to be suppressed. The polymer compound layer may contain, for example, any one or two or more types of polymer compounds such as polyvinylidene fluoride. This makes it easy to have excellent physical strength and to be electrochemically stable. For example, the polymer compound layer may contain any one or two or more types of insulating particles such as an inorganic particle. Examples of the kind of inorganic particles include aluminum oxide and/or aluminum nitride. Further, in the present disclosure, the separator 50 is not to be particularly limited by its name, and may be solid electrolytes, gel-like electrolytes, and/or insulating inorganic particles that have a similar function.

The electrolyte 20 that can be used in the secondary battery of the present disclosure may be a so-called “non-aqueous” electrolyte. The electrolyte, typically, the electrolytic solution contains a solvent and an electrolyte salt. The electrolytic solution may further contain any one or two or more of other materials such as additives. In a preferred embodiment, the separator may be impregnated with an electrolytic solution, and the positive electrode and/or the negative electrode may also be impregnated with an electrolytic solution.

The solvent may contain any one or two or more of non-aqueous solvents such as organic solvents. The electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile). This makes it easy to obtain further improved battery capacity, cycle characteristics, and/or storage characteristics. Examples of the cyclic carbonate ester may include ethylene carbonate, propylene carbonate, and/or butylene carbonate. Examples of the chain carbonate ester include dimethyl carbonate, diethyl carbonate, ethyl methyl carbonate, and/or methyl propyl carbonate. Examples of the lactone include γ-butyrolactone and/or γ-valerolactone. Examples of the chain carboxylate ester include methyl acetate, ethyl acetate, methyl propionate, ethyl propionate, methyl butyrate, methyl isobutyrate, methyl trimethylacetate, and/or ethyl trimethylacetate. Examples of the nitrile include acetonitrile, methoxyacetonitrile, and/or 3-methoxypropionitrile. Examples of the non-aqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide.

In particular, the non-aqueous solvent preferably contains one or two or more of ethylene carbonate, propylene carbonate, dimethyl carbonate, diethyl carbonate, ethyl methyl carbonate, and the like. This is because higher battery capacity, further improved cycle characteristics, and/or more excellent storage characteristics can be easily obtained. Further, examples of the non-aqueous solvent may include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This makes it easy to improve the chemical stability of the electrolytic solution. The “unsaturated cyclic carbonate ester” described herein is a cyclic carbonate ester having one or two or more unsaturated bonds (carbon-carbon double bonds or carbon-carbon triple bonds). Examples of the unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. When the halogenated carbonate ester contains two or more halogens as a constituent element, the type of the two or more halogens may be one type or two or more types.

The electrolyte salt contained in the electrolytic solution may include any one of, or two or more of salts such as a lithium salt, for example. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicated (Li₂SiF₆), lithium chloride (LiCl), and/or lithium bromide (LiBr). This is because further improved battery capacity, cycle characteristics, and/or storage characteristics can be easily obtained. Among them, one or two or more of lithium hexafluorophosphate, lithium tetrafluoroborate, lithium perchlorate, and lithium hexafluoroarsenate may be used.

The housing portion 500 used in the secondary battery corresponds to a member enclosing the electrode assembly 100 including the positive electrode 10B, the negative electrode 10A, and the separator 50. Such a housing portion 500 can also be referred to as, for example, a battery can. As an example, the housing portion 500 roughly includes an exterior body 200 having an opening portion on one end side, a sealing body 300 sealing the opening portion, and a gasket 400 functioning as a sealing material and an insulating material between the exterior body 200 and the sealing body 300.

The gasket 400 is positioned between an inner side surface on one end side of a side wall portion 220 of the exterior body 200 and an outer edge portion of the sealing body 300. The gasket 400 may be a resin member having insulating properties. In this case, for example, a propylene-based resin member, an acryl-based resin member, a silicone-based resin member, a urethane-based resin member, or the like can be used as the gasket 400.

The exterior body 200 includes the side wall portion 220 constituting or forming the opening portion and a bottom portion 210 continuous with the side wall portion 220. That is, the exterior body 200 may have a hollow structure. The sealing body 300 may have a positive electrode terminal 310 which may be positioned at the uppermost portion of the battery can, and a sealing plate 320 provided inside the positive electrode terminal 310 so as to be capable of coming into contact with the positive electrode terminal 310. The sealing plate 320 can function as a safety valve.

The exterior body 200 itself can function as a negative electrode terminal. The negative electrode 10A can be connected to the exterior body 200 via a conductive member on the negative electrode side. The constituent material of such a conductive member may include, for example, a nickel material. The exterior body 200 may be a conductive metal

member. For example, the exterior body 200 may contain iron, copper, nickel, stainless steel, an iron alloy, a copper alloy, and a nickel alloy, or the like. As the stainless steel, for example, SUS304, SUS316, and the like can be used.

The sealing plate 320 may include a first metal member 330, a second metal member 350, and an insulating member 340 positioned between the first metal member 330 and the second metal member 350, which are sequentially stacked in the lower side or the inner side direction with respect to the installation position of the positive electrode terminal 310 positioned on the upper side or the outer side.

In one example, the first metal member 330 is deformable and/or deformable so as to be cleavable according to the internal pressure in the battery can. The second metal member 350 can be displaced in accordance with an increase in the internal pressure of the battery can. The second metal member 350 and the positive electrode 10B of the electrode assembly 100 can be connected via a positive electrode tab 360. The positive electrode tab 360 may contain one of, or two or more of metal materials such as aluminum, titanium, platinum, and gold.

FIG. 1 illustrates a configuration in a normal state in which no gas or the like is generated in the battery can, where in the second metal member 350, a central region 352 inside the arrangement place of a groove portion 351 can come into contact with the first metal member 330. As described above, the first metal member 330 can come into contact with the positive electrode terminal 310. As described above, the positive electrode 10B in the battery can can be electrically connected to the positive electrode terminal 310.

Hereinafter, characteristic parts of the present disclosure will be described. The present disclosure is characterized by configuration of a predetermined portion of the positive electrode 10B which is a constituent element of the wound electrode assembly 100 and on which the positive electrode tab 360 is disposed.

Specifically, in the present disclosure, the positive electrode 10B includes a wound current collector 11B, and a first positive electrode material layer 12B1 and a second positive electrode material layer 12B2 provided on both surfaces of the current collector 11B. In a wound state of the electrode assembly 100, the first positive electrode material layer 12B1 may be located on the wound inner side, and the second positive electrode material layer 12B2 may be located on the wound outer side.

The positive electrode 10B includes a pair of exposed portions including a first exposed portion 11X in which one surface of a local portion of the current collector 11B is exposed and a second exposed portion 11Y in which the other surface facing the one surface in a thickness direction of the positive electrode 10B is exposed. That is, in the exposed portion, only the metal current collector is located, and the positive electrode material layer is not provided on both surfaces thereof.

The positive electrode tab 360 is provided on one of the first exposed portion 11X and the second exposed portion 11Y. A first insulating member 31 is provided so as to cover the first exposed portion 11X and a part of the first positive electrode material layer 12B1 located on both sides of the first exposed portion 11X in the circumferential direction of the positive electrode. A second insulating member 32 is provided so as to cover the second exposed portion 11Y and the second positive electrode material layer 12B2 located on both sides of the second exposed portion 11Y in the circumferential direction of the positive electrode.

In this case, in the present disclosure, in the circumferential direction of the positive electrode, one end 31X side of the first insulating member 31 and one end 32X side of the second insulating member 32 are arranged to be shifted from each other, and the other end 31Y side of the first insulating member 31 and the other end 32Y side of the second insulating member 32 are arranged to be shifted from each other.

A first end portion 12B11 of the first positive electrode material layer 12B1 and a first end portion 12B21 of the second positive electrode material layer 12B2 located on one side of the pair of exposed portions (the first exposed portion 11X and the second exposed portion 11Y) with reference to the circumferential direction of the positive electrode are arranged to be shifted from each other in the circumferential direction of the positive electrode. A second end portion 12B12 of the first positive electrode material layer 12B1 and a second end portion 12B22 of the second positive electrode material layer 12B2 located on the other side of the pair of exposed portions (the first exposed portion 11X and the second exposed portion 11Y) with reference to the circumferential direction of the positive electrode are arranged to be shifted from each other in the circumferential direction of the positive electrode.

According to the above configuration, in the circumferential direction of the positive electrode, the one end 31X side of the first insulating member 31 and the one end 32X side of the second insulating member 32 are arranged to be shifted from each other, and the other end 31Y side of the first insulating member 31 and the other end 32Y side of the second insulating member 32 are arranged to be shifted from each other. The first end portion 12B11 of the first positive electrode material layer 12B1 and the first end portion 12B21 of the second positive electrode material layer 12B2 are arranged to be shifted and the second end portion 12B12 of the first positive electrode material layer 12B1 and the second end portion 12B22 of the second positive electrode material layer 12B2 are arranged to be shifted in the circumferential direction of the positive electrode.

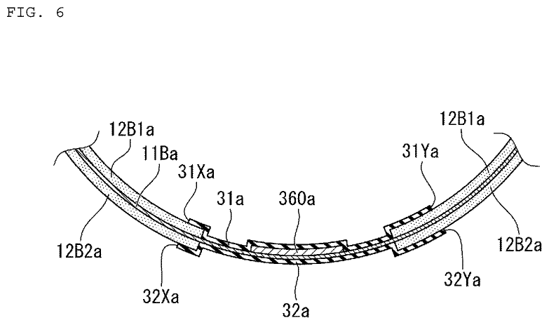

When the end portion of the first insulating member and the end portion of the second insulating member are arranged so as to be aligned in the thickness direction of the positive electrode and the end portion of the first positive electrode material layer and the end portion of the second positive electrode material layer are arranged so as to be aligned (see FIG. 6), the number of step portions, which can be formed in each local portion of the insulating tape covering the end portion of the insulating member and the end portion of the positive electrode material layer, may be 2.

On the other hand, in the present disclosure, the number of step portions, which can be formed in each local portion of the insulating tape covering the end portion of the insulating member and the end portion of the positive electrode material layer that can be arranged so as to be aligned in the thickness direction of the positive electrode, can be reduced from 2 to 1.

Since the step portion may have a bent portion due to its form, stress is likely to concentrate on a local portion of the separator 50 positioned to face the step portion; however, as described above, the number of step portions that can be arranged so as to be aligned in the thickness direction at a predetermined portion of the positive electrode can be reduced from 2 to 1.

From the same viewpoint, it is preferable that the first end portion 12B11 of the first positive electrode material layer 12B1 and the one end 32X side of the second insulating member 32 are arranged to be shifted from each other in the circumferential direction of the positive electrode. As a result, the number of stress concentration portions in the thickness direction at a predetermined portion of the positive electrode is also reduced, and stress acting on the separators 50 disposed opposite to each other on both sides of the positive electrode can be dispersed. As a result, breakage of the separator 50 that can be disposed on both sides of the positive electrode is suppressed, and occurrence of a short circuit can be suitably suppressed.

As described above, when the first positive electrode material layer 12B1 is located on the wound inner side, and the second positive electrode material layer 12B2 is located on the wound outer side, it is preferable that the one end 32X of the second insulating member 32 is located on a distal side of the one end 31X of the first insulating member 31 with reference to the arrangement place of the positive electrode tab 360 in the circumferential direction of the positive electrode.

According to such a configuration, when a force acts in the thickness direction of the positive electrode, the force can be more suitably received by the second insulating member 32 located between the positive electrode 10B and the separator 50 on one end side of the first insulating member 31 and the second insulating member 32. As a result, the second insulating member 32 functions as a buffer member, and the degree of direct facing contact between the positive electrode and the separator 50 can be reduced. As a result, breakage of the separator 50 is more suitably suppressed, and occurrence of a short circuit can be more suitably suppressed.

The present disclosure is not limited thereto, and from the same viewpoint, it is preferable that the other end 32Y of the second insulating member 32 is located on a distal side of the other end 31Y of the first insulating member 31 with reference to the arrangement place of the positive electrode tab 360 in the circumferential direction of the positive electrode.

Depending on the direction of the force acting in the thickness direction of the positive electrode, as illustrated in FIG. 3, the one end 31X of the first insulating member 31 may be located on a distal side of the one end 32X of the second insulating member 32 with reference to the arrangement place of the positive electrode tab 360 in the circumferential direction of the positive electrode.

From the viewpoint of ensuring the insulation property, the widths of the first insulating member 31 and the second insulating member 32 in the winding axis of the wound electrode assembly 100 are preferably larger than the width of the positive electrode material layer and cover a part of the positive electrode tab 360.

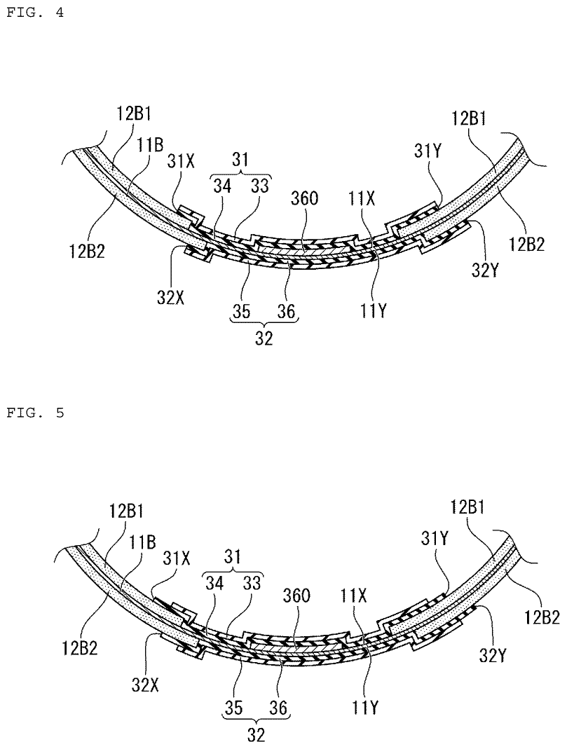

At least one insulating member of the first insulating member 31 and the second insulating member 32 may have a lamination structure (see FIGS. 4 and 5).

In this case, when the first insulating member 31 has a lamination structure, the first insulating member 31 has an insulating constituent member 34 on a relatively inner side and an insulating constituent member 33 on a relatively outer side, which are in contact with the current collector 11B and the positive electrode material layer, with reference to the arrangement place of the current collector 11B of the positive electrode. The insulating constituent member 33 on the relatively outer side may contain a material different from the insulating constituent member 34 on the relatively inner side.

When the second insulating member 32 has a lamination structure, the second insulating member 32 has an insulating constituent member 36 on the relatively inner side and an insulating constituent member 35 on the relatively outer side, which are in contact with the current collector 11B and the positive electrode material layer, with reference to the arrangement place of the current collector 11B of the positive electrode. The insulating constituent member 35 on the relatively outer side may contain a material different from the insulating constituent member 36 on the relatively inner side.

In the first insulating member 31 and/or the second insulating member 32, the insulating constituent member on the relatively inner side contains an elastoplastically deformable resin material, that is, a resin material having a yield point, preferably a resin material having a yield point. As an example, a resin material such as polyimide, low-density polyethylene, or polyvinyl chloride (soft) can be used. On the other hand, the insulating constituent member on the relatively outer side contains a resin material having relatively higher strength resistance than the insulating constituent member on the inner side. As an example, a material such as PET, polyamide, or polypropylene can be used.

The insulating constituent member on the relatively inner side can be in contact with the electrode material layer, but since the insulating constituent member on the inner side contains a resin material having a yield point, when an external force is applied to the electrode assembly along the thickness direction of the positive electrode, the electrode assembly is easily deformed by the external force. Since the insulating constituent member on the relatively outer side can contain a resin material having relatively high strength resistance, the strength of the insulating member as a whole can be satisfied.

From the above, when an external force is applied to the electrode assembly along the thickness direction of the positive electrode, the number of stress concentration portions in the thickness direction at a predetermined portion of the positive electrode is also more reduced, and stress acting on the separators 50 disposed opposite to each other on both sides of the positive electrode can be more dispersed. As a result, breakage of the separator 50 that can be disposed on both sides of the positive electrode is more suppressed, and occurrence of a short circuit can be more suitably suppressed.

In particular, as for the insulating member having a lamination structure, it is more preferable that an end portion of the insulating constituent member on the relatively inner side and an end portion of the insulating constituent member on the relatively outer side are arranged to be shifted from each other in the circumferential direction of the positive electrode (see FIG. 5).

Specifically, when the first insulating member 31 has a lamination structure, one in which one end 34X of the insulating constituent member 34 on the relatively inner side and one end 33X of the insulating constituent member 33 on the relatively outer side are arranged to be shifted from each other can be used. Additionally or alternatively, one in which the other end 34Y of the insulating constituent member 34 on the relatively inner side and the other end 33Y of the insulating constituent member 33 on the relatively outer side are arranged to be shifted from each other can be used.

When the second insulating member 32 has a lamination structure, one in which one end 36X of the insulating constituent member 36 on the relatively inner side and one end 35X of the insulating constituent member 35 on the relatively outer side are arranged to be shifted from each other can be used. Additionally or alternatively, one in which the other end 36Y of the insulating constituent member 36 on the relatively inner side and the other end 35Y of the insulating constituent member 35 on the relatively outer side are arranged to be shifted from each other can be used.

According to such a configuration, the thickness of the end portions of the insulating members 31 and 32 can be reduced, so that stress dispersion in the thickness direction of the end portions can be further achieved. As a result, breakage of the separator 50 that can be disposed on both sides of the positive electrode is further suppressed, and occurrence of a short circuit can be further suitably suppressed.

Hereinafter, a method of manufacturing a secondary battery according to an embodiment of the present disclosure will be described.

First, a positive electrode mixture containing a positive electrode active material is formed, and the positive electrode mixture is dispersed in an organic solvent to obtain a paste-like positive electrode mixture slurry. After a space for forming an exposed portion of a current collector for providing an electrode tab described later is secured on both sides of a main surface of a metal foil as a positive electrode current collector, the positive electrode mixture slurry is applied, and the positive electrode mixture slurry is dried to prepare a positive electrode. Thereafter, the positive electrode is pressurized using a roll press machine.

Similarly, a negative electrode mixture containing a negative electrode active material is formed, and the negative electrode active material is dispersed in an organic solvent to obtain a paste-like negative electrode mixture slurry. After a space for forming an exposed portion of a current collector for providing an electrode tab described later is secured on both sides of a main surface of a metal foil as a negative electrode current collector, the negative electrode mixture slurry is applied, and the negative electrode mixture slurry is dried to prepare a negative electrode. Thereafter, the negative electrode is pressurized using a roll press machine.

Thereafter, a positive electrode tab is connected to one of the exposed portions formed on both sides of the metal foil as a positive electrode current collector. A negative electrode tab is connected to one of the exposed portions formed on both sides of the metal foil as a negative electrode current collector. After the electrode tab is connected, an insulating tape (insulating member) is attached so as to cover a part of the electrode material layer located on both sides of each exposed portion in the longitudinal direction of the current collecting foil and the exposed portion.

At this time, alignment is performed such that the following configuration is realized according to an embodiment.
At least in the positive electrode, in the circumferential direction of the positive electrode, one end side of the first insulating member and one end side of the second insulating member are arranged to be shifted from each other, and the other end side of the first insulating member and the other end side of the second insulating member are arranged to be shifted from each other.
The first end portion of the first positive electrode material layer and the first end portion of the second positive electrode material layer located on one side of the pair of exposed portions with reference to the longitudinal direction of the positive electrode are arranged to be shifted in the circumferential direction of the positive electrode, and the second end portion of the first positive electrode material layer and the second end portion of the second positive electrode material layer located on the other side of the pair of exposed portions are arranged to be shifted in the circumferential direction of the positive electrode.

Next, the positive electrode and the negative electrode are stacked with the separator interposed therebetween, and the positive electrode, the negative electrode, and the separator are wound to form an electrode assembly. Then, the electrode assembly 100 is housed inside the exterior body 200, one end portion of the positive electrode tab 360 is connected to the second metal member 350 of the sealing plate 320 by welding, and one end portion of the negative electrode tab is connected to the inner surface of the exterior body 200 by the same method. Next, the electrolytic solution is injected into the exterior body 200, and the electrode assembly is impregnated with the electrolytic solution. Subsequently, the side wall portion 220 of the exterior body 200 is caulked using a caulking member such that one end side of the side wall portion 220 of the exterior body 200 is positioned on the upper side of the outer edge of the sealing body 300.

As described above, the secondary battery 1000 of the present disclosure can be manufactured.

Although an embodiment of the present disclosure have been described herein, typical examples have been only illustrated. The present disclosure is not limited thereto, and various embodiments are conceivable without changing the scope of the present disclosure.

### EXAMPLES

Hereinafter, Examples 1 to 3 will be described according to an embodiment.

### Example 1

First, as a positive electrode production step, a positive electrode mixture containing a positive electrode active material was formed, and the positive electrode mixture was dispersed in an organic solvent to obtain a paste-like positive electrode mixture slurry. After a space for forming an exposed portion of a current collector for providing a positive electrode tab was secured on both sides of a main surface of a metal foil as a positive electrode current collector, the positive electrode mixture slurry was applied, and the positive electrode mixture slurry was dried to prepare a positive electrode. In this case, a positive electrode tab was provided, and then the positive electrode was pressurized using a roll press machine.

Similarly, as a negative electrode production step, a negative electrode mixture containing a negative electrode active material was formed, and the negative electrode active material was dispersed in an organic solvent to obtain a paste-like negative electrode mixture slurry. After a space for forming an exposed portion of a current collector for providing an electrode tab described later was secured on both sides of a main surface of a metal foil as a negative electrode current collector, the negative electrode mixture slurry was applied, and the negative electrode mixture slurry was dried to prepare a negative electrode. Thereafter, the negative electrode was pressurized using a roll press machine. Thereafter, the positive electrode tab was connected to the exposed portion of the metal foil as a positive electrode current collector, and the negative electrode tab was connected to the exposed portion of the metal foil as a negative electrode current collector.

After each electrode tab was connected, an insulating tape (insulating member) was attached so as to cover a part of the electrode material layer located on both sides of each exposed portion in the longitudinal direction of the current collecting foil and the exposed portion. In particular, in the formation of the positive electrode, alignment was adjusted so that the exposed portions formed on both surfaces of the metal foil, the insulating tape, and the positive electrode material had the following configurations.
At least in the positive electrode, in the circumferential direction of the positive electrode, one end side of the first insulating member and one end side of the second insulating member are arranged to be shifted from each other, and the other end side of the first insulating member and the other end side of the second insulating member are arranged to be shifted from each other.
The first end portion of the first positive electrode material layer and the first end portion of the second positive electrode material layer located on one side of the pair of exposed portions with reference to the longitudinal direction of the positive electrode are arranged to be shifted in the circumferential direction of the positive electrode, and the second end portion of the first positive electrode material layer and the second end portion of the second positive electrode material layer located on the other side of the pair of exposed portions are arranged to be shifted in the circumferential direction of the positive electrode.
From the viewpoint of ensuring the insulation property, each insulating member having a size in which the widths of the first insulating member and the second insulating member in the winding axis at the time of producing a wound electrode assembly described below are larger than the width of the positive electrode material layer and have a positional relationship of covering a part of the positive electrode tab was used.

Thereafter, the positive electrode and the negative electrode were stacked with the separator interposed therebetween, and then the positive electrode, the negative electrode, and the separator were wound to form the electrode assembly. An impact test was performed on the secondary battery including the electrode assembly. At that time, the thickness of the positive electrode material layer was 110 to 120 μm, and the thickness of the metal foil was 12 μm. As a condition of the impact test, a 9.1 kg weight was collided from a height of 610 mm above the batteries. The acceptance rate of the collision test was 97.6% in total.

The impact test is based on the standard of UL1642_Ed.6.

Specifically, as a basic form, the impact test is performed through the following steps.
A test sample (cell to be prepared) is charged to 4.25 V at room temperature.
The test sample is placed on a flat surface. A bar having a diameter of 15.8±0.1 mm (⅝±0.004 inches) is placed across the center of the sample.
A 9.1±0.46 kg (20±1 pounds) weight is dropped from a height of 610±25 mm (24±1 inches) onto the sample.
A cylindrical, pouch, or prismatic cell is impacted with its longitudinal axis parallel to the flat surface and perpendicular to the longitudinal axis of the 15.8 mm (⅝-inch) diameter curved surface lying across the center of the test sample. A prismatic cell is rotated by 90 degrees around its longitudinal axis so that both the wide and narrow sides are subjected to the impact. Each sample is subjected to only a single impact.
Separate samples are used for each test.

### Example 2

Hereinafter, Example 2 will be described. In Example 2, in order to avoid overlapping with the contents described in Example 1, parts different from the contents described in Example 1 will be mainly described.

Similarly to Example 1, after each electrode tab was connected, an insulating tape (insulating member) was attached so as to cover a part of the electrode material layer located on both sides of the exposed portion formed on each main surface of the positive electrode current collector 11B in the longitudinal direction of the current collecting foil and the exposed portion.

In particular, in Example 2, unlike Example 1, not a single-layer insulating member but each insulating member of a lamination structure (corresponding to each of the first insulating member 31 and the second insulating member 32 in Example 1) were bonded on each main surface side of the positive electrode current collector 11B. As the first insulating member 31 of such a lamination structure, one composed of the insulating constituent member 34 on the relatively inner side and the insulating constituent member 33 on the relatively outer side, which are in direct contact with the positive electrode current collector 11B, with reference to the arrangement place of the positive electrode current collector 11B was used. As the second insulating member 32 of such a lamination structure, one composed of the insulating constituent member 36 on the relatively inner side and the insulating constituent member 35 on the relatively outer side, which are in direct contact with the positive electrode current collector 11B, with reference to the arrangement place of the positive electrode current collector 11B was used.

In Example 2, the first insulating member 31 of the lamination structure having no deviation at both end portions was used.

Specifically, among the first insulating members 31 of a lamination structure, one in which the one end 34X of the insulating constituent member 34 on the relatively inner side and the one end 33X of the insulating constituent member 33 on the relatively outer side are not shifted from each other was used. In addition, among the first insulating members 31 of a lamination structure, one in which the other end 34Y of the insulating constituent member 34 on the relatively inner side and the other end 33Y of the insulating constituent member 33 on the relatively outer side are not shifted from each other was used.

Among the second insulating members 32 of a lamination structure, one in which the one end 36X of the insulating constituent member 36 on the relatively inner side and the one end 35X of the insulating constituent member 35 on the relatively outer side are not shifted from each other was used. In addition, among the second insulating members 32 of a lamination structure, one in which the other end 36Y of the insulating constituent member 36 on the relatively inner side and the other end 35Y of the insulating constituent member 35 on the relatively outer side are not shifted from each other was used.

Thereafter, the positive electrode and the negative electrode were stacked with the separator interposed therebetween, and then the positive electrode, the negative electrode, and the separator were wound to form the electrode assembly. An impact test was performed on the secondary battery including the electrode assembly. As a condition of the impact test, a 9.1 kg weight was collided from a height of 610 mm above the batteries. The acceptance rate of the impact test was 98.0% in total.

### Example 3

Hereinafter, Example 3 will be described. In Example 3, parts different from the contents described in Example 2 will be mainly described.

Similarly to Example 2, after each electrode tab was connected, an insulating tape (insulating member) was attached so as to cover a part of the electrode material layer located on both sides of the exposed portion formed on each main surface of the positive electrode current collector 11B in the longitudinal direction of the current collecting foil and the exposed portion.

In particular, in Example 3, as in Example 2, not a single-layer insulating member but each insulating member of a lamination structure (corresponding to each of the first insulating member 31 and the second insulating member 32 in Example 1) were bonded on each main surface side of the positive electrode current collector 11B. As the first insulating member 31 of such a lamination structure, one composed of the insulating constituent member 34 on the relatively inner side and the insulating constituent member 33 on the relatively outer side, which are in direct contact with the current collector 11B, with reference to the arrangement place of the current collector 11B was used. As the second insulating member 32 of such a lamination structure, one composed of the insulating constituent member 36 on the relatively inner side and the insulating constituent member 35 on the relatively outer side, which are in direct contact with the current collector 11B, with reference to the arrangement place of the current collector 11B was used.

On the other hand, in Example 3, unlike Example 2, the first insulating member 31 of the lamination structure having deviation at both end portions was used.

Specifically, among the first insulating members 31 of a lamination structure, one in which the one end 34X of the insulating constituent member 34 on the relatively inner side and the one end 33X of the insulating constituent member 33 on the relatively outer side are shifted from each other was used. In addition, among the first insulating members 31 of a lamination structure, one in which the other end 34Y of the insulating constituent member 34 on the relatively inner side and the other end 33Y of the insulating constituent member 33 on the relatively outer side are shifted from each other was used.

Among the second insulating members 32 of a lamination structure, one in which the one end 36X of the insulating constituent member 36 on the relatively inner side and the one end 35X of the insulating constituent member 35 on the relatively outer side are shifted from each other was used. In addition, among the second insulating members 32 of a lamination structure, one in which the other end 36Y of the insulating constituent member 36 on the relatively inner side and the other end 35Y of the insulating constituent member 35 on the relatively outer side are shifted from each other was used.

Thereafter, the positive electrode and the negative electrode were stacked with the separator interposed therebetween, and then the positive electrode, the negative electrode, and the separator were wound to form the electrode assembly. An impact test was performed on the secondary battery including the electrode assembly. As a condition of the impact test, a 9.1 kg weight was collided from a height of 610 mm above the batteries. The acceptance rate of the impact test was 98.2% in total.

### Comparative Example

Hereinafter, Comparative Example will be described. In Comparative Example, in order to avoid overlapping with the contents described in Examples, parts different from the contents described in Examples will be mainly described.

In Comparative Example, unlike Examples described above, in the obtained positive electrode, the configurations of the exposed portions formed on both surfaces of the metal foil, the insulating tape, and the positive electrode material were as follows without performing alignment adjustment as in Examples.
At least in the positive electrode, in the thickness direction of the positive electrode, one end side of the first insulating member and one end side of the second insulating member are disposed on the same line, and the other end side of the first insulating member and the other end side of the second insulating member are disposed on the same line.
The first end portion of the first positive electrode material layer and the first end portion of the second positive electrode material layer located on one side of the pair of exposed portions with reference to the longitudinal direction of the positive electrode are disposed on the same line in the thickness direction of the positive electrode, and the second end portion of the first positive electrode material layer and the second end portion of the second positive electrode material layer located on the other side of the pair of exposed portions are disposed on the same line in the thickness direction of the positive electrode. Also in Comparative Example, the impact test was performed in the same manner as in Examples, and the acceptance rate of the impact test was 63.3% in total.

As described above, according to the configurations of Examples 1 to 3, it was found that the acceptance rate of the impact test can be improved as compared with Comparative Example.

Also from the above test results, it was found that the number of stress concentration portions in the thickness direction at a predetermined portion of the positive electrode is reduced, and stress acting on the separators disposed opposite to each other on both sides of the positive electrode can be dispersed. As a result, it was found that breakage of the separator that can be disposed on both sides of the positive electrode is suppressed, and occurrence of a short circuit can be suitably suppressed.

It is to be noted that an embodiment of the present disclosure as described above encompasses the following preferable aspects.

<1>

A secondary battery including:
a wound electrode assembly in which a positive electrode, a negative electrode, and a separator disposed between the positive electrode and the negative electrode are wound; and an electrolyte, the wound electrode assembly and the electrolyte being enclosed in an exterior body,
at least the positive electrode including a wound current collector, a first positive electrode material layer and a second positive electrode material layer provided on both surfaces of the current collector, and a pair of exposed portions including a first exposed portion in which one surface of a local portion of the current collector is exposed and a second exposed portion in which the other surface facing the one surface in a thickness direction of the positive electrode is exposed,
the positive electrode further including:
a positive electrode tab provided on one of the first exposed portion and the second exposed portion,
a first insulating member covering the first exposed portion and the first positive electrode material layers located on both sides of the first exposed portion in a circumferential direction of the positive electrode, and
a second insulating member covering the second exposed portion and the second positive electrode material layers located on both sides of the second exposed portion in the circumferential direction of the positive electrode,
wherein
in the wound electrode assembly, the first positive electrode material layer is located on a wound inner side, and the second positive electrode material layer is located on a wound outer side, and in the circumferential direction of the positive electrode, one end side of the first insulating member and one end side of the second insulating member are arranged to be shifted from each other, and the other end side of the first insulating member and the other end side of the second insulating member are arranged to be shifted from each other, and
a first end portion of the first positive electrode material layer and a first end portion of the second positive electrode material layer located on one side of the pair of exposed portions with reference to the circumferential direction of the positive electrode are arranged to be shifted in the circumferential direction of the positive electrode, and a second end portion of the first positive electrode material layer and a second end portion of the second positive electrode material layer located on the other side of the pair of exposed portions are arranged to be shifted in the circumferential direction of the positive electrode.
   <2>

The secondary battery according to <1>, wherein an end portion of the second insulating member is located on a distal side of an end portion of the first insulating member with reference to an arrangement place of the positive electrode tab in the circumferential direction of the positive electrode.

<3>

The secondary battery according to <1> or <2>, wherein the first end portion of the first positive electrode material layer and the one end side of the second insulating member are arranged to be shifted from each other in the circumferential direction of the positive electrode.

<4>

The secondary battery according to any one of <1> to <3>, wherein at least one insulating member of the first insulating member and the second insulating member has a lamination structure, and the insulating member of the lamination structure has an insulating constituent member on a relatively inner side and an insulating constituent member on a relatively outer side containing a material different from the insulating constituent member on the relatively inner side, which are in contact with the current collector and the positive electrode material layer, with reference to the arrangement place of the current collector of the positive electrode.

<5>

The secondary battery according to <4>, wherein the insulating constituent member on the relatively inner side of the insulating member contains a resin material having a yield point.

<6>

The secondary battery according to <4> or <5>, wherein an end portion of the insulating constituent member on the relatively inner side and an end portion of the insulating constituent member on the relatively outer side of the insulating member of the lamination structure are arranged to be shifted from each other in the circumferential direction of the positive electrode.

The secondary battery according to the present disclosure can be typically used for applications in which use of electric energy is required according to an embodiment. For example, the secondary battery according to the present disclosure can be used in various fields in which electric storage is assumed. As a mere example, the battery of the present disclosure can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic paper, wearable devices, and small electronic equipment such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical equipment fields such as earphone hearing aids), pharmaceutical applications (fields such as dosage management systems), IoT fields, space and deep sea applications (for example, the fields of a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a wound electrode assembly in which a positive electrode, a negative electrode, and a separator disposed between the positive electrode and the negative electrode are wound; and an electrolyte, the wound electrode assembly and the electrolyte being enclosed in an exterior body,
at least the positive electrode including a wound current collector, a first positive electrode material layer and a second positive electrode material layer provided on both surfaces of the current collector, and a pair of exposed portions including a first exposed portion in which one surface of a local portion of the current collector is exposed and a second exposed portion in which the other surface facing the one surface in a thickness direction of the positive electrode is exposed,
the positive electrode further including:
a positive electrode tab provided on one of the first exposed portion and the second exposed portion,
a first insulating member covering the first exposed portion and the first positive electrode material layers located on both sides of the first exposed portion in a circumferential direction of the positive electrode, and
a second insulating member covering the second exposed portion and the second positive electrode material layers located on both sides of the second exposed portion in the circumferential direction of the positive electrode,
wherein
in the wound electrode assembly, the first positive electrode material layer is located on a wound inner side, and the second positive electrode material layer is located on a wound outer side, and in the circumferential direction of the positive electrode, one end side of the first insulating member and one end side of the second insulating member are arranged to be shifted from each other, and the other end side of the first insulating member and the other end side of the second insulating member are arranged to be shifted from each other, and
a first end portion of the first positive electrode material layer and a first end portion of the second positive electrode material layer located on one side of the pair of exposed portions with reference to the circumferential direction of the positive electrode are arranged to be shifted in the circumferential direction of the positive electrode, and a second end portion of the first positive electrode material layer and a second end portion of the second positive electrode material layer located on the other side of the pair of exposed portions are arranged to be shifted in the circumferential direction of the positive electrode.

2. The secondary battery according to claim 1, wherein an end portion of the second insulating member is located on a distal side of an end portion of the first insulating member with reference to an arrangement place of the positive electrode tab in the circumferential direction of the positive electrode.

3. The secondary battery according to claim 1, wherein the first end portion of the first positive electrode material layer and the one end side of the second insulating member are arranged to be shifted from each other in the circumferential direction of the positive electrode.

4. The secondary battery according to claim 1, wherein at least one insulating member of the first insulating member and the second insulating member has a lamination structure, and the insulating member of the lamination structure has an insulating constituent member on a relatively inner side and an insulating constituent member on a relatively outer side containing a material different from the insulating constituent member on the relatively inner side, which are in contact with the current collector and the positive electrode material layer, with reference to the arrangement place of the current collector of the positive electrode.

5. The secondary battery according to claim 4, wherein the insulating constituent member on the relatively inner side of the insulating member contains a resin material having a yield point.

6. The secondary battery according to claim 4, wherein an end portion of the insulating constituent member on the relatively inner side and an end portion of the insulating constituent member on the relatively outer side of the insulating member of the lamination structure are arranged to be shifted from each other in the circumferential direction of the positive electrode.
